(19) United States
(12) Patent Application Publication
(10) Pub. No.: US 2026/0241432 A1
(43) Pub. Date: Aug. 20, 2026

(54) METHOD FOR PRODUCING AN EMBOSSING TOOL FOR BIPOLAR PLATES AND EMBOSSING TOOL

(71) Applicant: ELRINGKLINGER AG, Dettingen an der Erms (DE)

(72) Inventors: Marko DREWS, Dettingen an der Erms (DE); Bernd SCHAEFER, Dettingen an der Erms (DE); Benjamin ULMER, Dettingen an der Erms (DE)

(21) Appl. No.: 19/493,446

(22) PCT Filed: May 24, 2024
(86) PCT No.: PCT/EP2024/064391

§ 371 Date: Dec. 15, 2025

(30) Foreign Application Priority Data
May 25, 2023 (DE) 102023113800.6

(51) Int. Cl. B21D 22/02; B21D 37/02; B23P 15/24

(52) U.S. Cl. CPC B21D 22/02; B21D 37/02; B23P 15/24

(57) ABSTRACT

A method for producing an embossing tool for producing bipolar plates, which has an embossing field, comprises the steps of: milling, in a first step, an erosion electrode and eroding, in a second step, the embossing field or an embossing plate of the embossing field by means of the erosion electrode. An embossing tool for producing bipolar plates has an embossing field wherein the embossing field has a plurality of embossing plates arranged adjacent to one another.

The invention relates to a method for producing an embossing tool for producing bipolar plates as well as an embossing tool obtainable therefrom for producing bipolar plates.

Bipolar plates of the type mentioned here are used, for example, in fuel cells, in particular oxygen-hydrogen fuel cells. Depending on the design of the bipolar plate, it is produced from 2 to 4 plate blanks that are arranged on each other and attached to each other. Very simple versions of bipolar plates can also be produced directly without having to produce plate blanks first.

The plate blanks are produced in particular by means of an embossing method in which an embossing tool imprints a surface structure into the sides of the plate blank. Depending on how the surface structure is designed, internal channels for the passage of cooling water can be formed by joining a plurality of plate blanks together.

The embossing tools used for this embossing method must be made very precisely since the quality of the surface structure of the plate blanks has a direct influence on the quality and efficiency of the fuel cell that can be produced therefrom. Therefore, such embossing tools are usually produced by high-speed machining by means of a milling device. Due to the large number of fine structures, the production of such an embossing tool takes very long, for example several hundreds of hours, which entails high costs. Furthermore, the optimal geometries of the surface structure can only be approximated represented by means of milling heads, wherein a certain degree of gradation of curves is unavoidable.

If damage occurs to the milled embossing tool, repairs are involved. One possible repair method involves re-milling part or even the entire embossing plate. The effort for this varies depending on the type of damage, but is considerable even for minor damage. If the entire embossing plate needs to be re-milled, then the effort involved is very high.

Against this background, the object of the present invention is to propose a method for producing an embossing tool that is more economical and flexible to carry out than known producing methods and that exhibits improved accuracy compared to known methods. Furthermore, the object of the present invention aims to propose an embossing tool that is more economical and more flexible to use.

The object is achieved by a method in accordance with claim 1 and an embossing tool in accordance with claim 4. Advantageous embodiments are the subject of the dependent claims.

To achieve this object, a method for producing an embossing tool for producing bipolar plates, which has an embossing field, comprises the following steps: milling, in a first step, an erosion electrode and eroding, in a second step, an embossing plate of the embossing field by means of the erosion electrode.

The erosion electrode is not worn down, or only minimally worn, by the erosion method so that an erosion electrode produced once can be used to manufacture a large number of embossing tools. Although the production of the erosion electrode is initially about as involved as the production of the embossing tool by milling, as soon as the embossing tool needs to be produced again, for example to replace a damaged embossing tool, a new embossing tool can be produced quickly and economically by means of the prepared erosion electrode.

Milling complex geometries almost always results in inaccuracies and gradations. This results from the fact that not every geometry is available as a milling head. Moving the milling head during machining yields an approximation of the desired geometry. Erosion methods such as PCM or PECM methods can create rounded geometries so that the embossing plate is produced true to geometry and does not have the usual gradations in milling. This avoids corresponding inaccuracies which can, for example, also lead to undesirable weak points at which fractures frequently occur.

In some embodiments, the method includes the step: arranging, in a third step, a plurality of embossing plates in the embossing field.

Because the embossing field is made of a plurality of embossing plates, repairing the embossing field is simplified. If damage occurs to one of the embossing plates of the embossing field, it is now enough to replace the individual damaged embossing plate instead of having to recreate the entire embossing field. Therefore, in the event of damage, it is also no longer necessary to keep a complete embossing field on hand, but only the smaller and significantly more economical embossing plates.

Furthermore, the yield is greater when eroding the smaller embossing plates, since any error in production only affects the small embossing plate and not the entire embossing area. This also reduces the overall material and time expenditure.

In some embodiments, the method includes the step: introducing, in a fourth step, a positioning structure and/or an orientation structure into the embossing plate to determine a position and/or an orientation of the embossing plate in the embossing field.

This simplifies the assembly of the embossing field. This is because the embossing plates can be aligned with each other with the positioning structure and/or the orientation structure, and can be centered, for example.

The object is further achieved by an embossing tool for producing bipolar plates, which has an embossing field, wherein the embossing field has a plurality of embossing plates arranged adjacent to one another.

The construction of the embossing field from a plurality of embossing plates has in particular the advantage that the embossing field can be repaired easily and inexpensively. This is because in the event of damage to one of the embossing plates, only that embossing plate needs to be replaced, and not an entire, much more expensive and material-intensive embossing field.

In some embodiments, at least one section of the embossing field is formed from identical embossing plates. In particular, if the embossing field has surface structures that are repeated over a large area, such a division of the embossing field into many identically designed embossing plates is advisable. In this case, it is not necessary to keep a copy of each embossing plate on hand in the event of a repair, but only an appropriate quantity of identically designed embossing plates. This saves material, and the costs of storage are reduced.

In some embodiments, at least one of the embossing plates has a positioning structure and/or an orientation structure for determining a position and/or an orientation of the embossing plate relative to another embossing plate and/or the embossing field.

This simplifies the assembly of the embossing field. This is because the embossing plates can be aligned with each other with the positioning structure and/or the orientation structure, and can be centered, for example.

In some embodiments, the embossing plates are obtained by means of an erosion method.

This makes production particularly inexpensive and quick. In addition, the erosion method has the advantage over a milling method that a higher geometric accuracy is achieved.

Further features and variants of the invention are in particular apparent from the accompanying figures, which show forms of the invention solely schematically and by way of example. In detail:

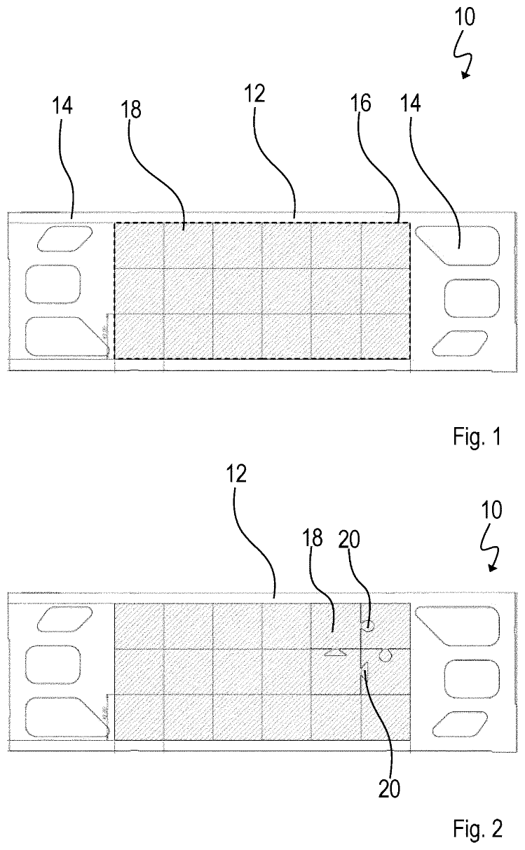

FIG. 1 shows a frontal view of an embossing tool in accordance with an embodiment of the invention;

FIG. 2 shows a view as in FIG. 1 of an embossing tool in accordance with a further embodiment of the invention, and

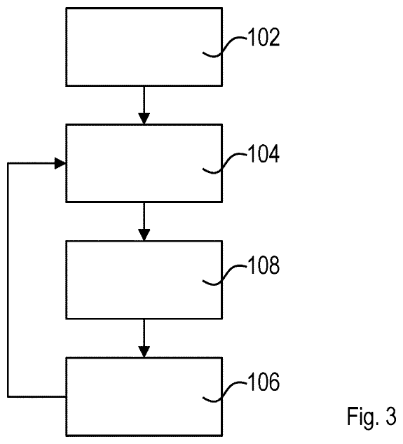

FIG. 3 shows a schematic flowchart of a production method in accordance with an embodiment of the invention.

The figures contain partially simplified, schematic representations. Sometimes, identical reference signs are used for like elements that may not be identical. Different views of the same elements may be scaled differently. Directional terms such as “left,” “right,” “up” and “down” are to be understood in relation to the respective figure and can vary in the individual representations compared to the represented object. Furthermore, elements are not necessarily shown to scale, in particular for the purpose of simplifying and clearly illustrating their functional relationships relative to each other. If method steps or elements are labeled with enumerative terms such as “first,” “second”, “third” and “further”, these terms, unless explicitly disclosed otherwise, serve only for differentiation and do not imply any order or hierarchy.

An embossing tool 10 shown in FIG. 1 has an embossing field 12 on a side facing the viewer which has embossing structures for embossing into a plate blank of a bipolar plate for a fuel cell, in particular a hydrogen-oxygen fuel cell. In lateral regions of the embossing field 12, inlet and outlet structures 14 are arranged which generate inlets and outlets (manifold) during the embossing of the plate blank and/or prepare their generation. Arranged in between is a flow profile structure 16 which generates a flow profile (English: flow field) while embossing the plate blank.

The flow profile structure 16 has a plurality of embossing plates 18 which are arranged adjacent to one another in an in particular a right-angled grid. Each of the embossing plates 18 has a square outline and has a section of the flow profile structure 16 on its side facing the viewer. The flow profile structure 16 is designed such that the embossing plates 18 are identical to each other. This can mean, for example, that the flow profile structure 16 repeats at regular intervals, wherein the embossing plates 18 having dimensions that are an integral multiple of this regular interval.

If one of the embossing plates 18 is damaged, it can be replaced individually.

To correctly arrange the embossing plates 18 in the embossing field 12, the embossing plates 18 can have structures 20 as shown in FIG. 2 that determine a position and/or an orientation of the embossing plates 18, i.e., function as positioning structures and/or orientation structures. The structures 20 can determine a position and/or an orientation of the embossing plates 18 relative to each other and/or determine a position and/or an orientation relative to the rest of the embossing field 12. For this purpose, the rest of the embossing field 12 can also have corresponding structures 20.

Since steps or gaps should not be formed between the embossing plates 18 if possible, the structures 20 can, for example, define such an arrangement without steps or gaps by determining the position and/or orientation of the embossing plates 18 relative to each other.

The structures 20 can, for example, be designed like a puzzle such that an embossing plate 18 has a recess, and the adjacent embossing plate 18 has a projection of a corresponding shape. The two embossing plates 18 can then be fitted together like a puzzle, wherein the recess and the projection determine their position relative to each other. Additionally or alternatively, any structures 20 incorporated into the side edges of the embossing plate 18 can be provided, which can form a releasable form-fit.

In some embodiments, the embossing field 12 can also be produced in one piece. In this case, the possibility of exchanging individual embossing plates 18 is eliminated.

To produce the embossing tool 10 as shown in FIG. 3, in a first method step 102, an erosion electrode for precise electrochemical metalworking (PECM) is milled. In a second method step 104, the embossing field 12 or an embossing plate of the embossing field is eroded by means of the erosion electrode by means of precise electrochemical metalworking.

If the embossing field 12 has a receptacle for embossing plates 18, then in a third step 106, a plurality of embossing plates 18 can be arranged in the embossing field 12.

In some embodiments, it can be provided that in a fourth step 108 which does not necessarily follow the third step 106, the structure 20, i.e., for example, a positioning structure and/or an orientation structure for determining the position and/or orientation of the embossing plate 18 in the embossing field 12, is introduced into the embossing plate 18.

In precision electrochemical machining (PECM), the material of the workpiece is removed by means of an erosion electrode and an electrolyte introduced between the erosion electrode and the workpiece, for example a blank for an embossing field 12 or an embossing plate 18, by means of a current flow so that the structures of the erosion electrode are inverted in its surface. This is done at room temperature so that in particular no structural changes are caused in the workpiece.

Because the erosion electrode is not worn down in the method, it can be used again at any time for producing another embossing field 12 or an embossing plate 18. This results in significant savings in materials and effort. This is because instead of a complete milling process in which a new embossing field 12 or a new embossing plate 18 is created, only a PECM method, which is orders of magnitude faster, needs to be carried out in which the new embossing field 12 or the new embossing plate 18 is eroded. Accordingly, the costly milling process for a specific model of the embossing field 12 or the embossing plate 18 is only performed once.

In the above embodiments, the embossing plates 18 are shown with a substantially rectangular or square outline. Regardless of other features, the embossing plates can have 18 other outlines, for example a rectangular, hexagonal, octagonal or parallelogram-shaped outline. In principle, embossing plates 18 can be used in any tiling, for example Laves nets, Cairo tiling, Archimedean tiling, semi-regular tiling, homogeneous tiling, triangular tiling or square tiling. The use of concave quadrilaterals or polygons is also conceivable. If necessary, end embossing plates 18 with an outline adapted to the edge of the embossing field 12 are provided in the edge region of the embossing field 12.

In some embodiments, the embossing plates 18 can be clamped and/or pinned together by means of a clamping device which may be formed, for example, by the outer edges of the embossing field 12.

“Can” in particular denotes optional features of the invention. Accordingly, there are also further developments and/or exemplary embodiments of the invention that additionally or alternatively have the particular feature or particular features.

From the combinations of features disclosed herein, isolated features can also be selected as needed and, by dissolving any structural and/or functional relationship that may exist between the features, used in combination with other features to define the subject matter of the claim.

### LIST OF REFERENCE SIGNS

10 embossing tools
12 embossing field
14 inlet and outlet structures (manifold)
16 flow profile structure
18 embossing plate
20 structure/positioning structure/orientation structure
102 first method step
104 second method step
106 third method step
108 fourth method step

1. A method for producing an embossing tool for producing bipolar plates, which has an embossing field, comprising steps:
a) milling, in a first step, an erosion electrode
b) eroding, in a second step, the embossing field or an embossing plate of the embossing field by means of the erosion electrode.

2. The method in accordance with claim 1, comprising the step c) arranging, in a third step, a plurality of embossing plates in the embossing field.

3. The method in accordance with claim 1, comprising step d) Introducing, in a fourth step, a positioning structure and/or an orientation structure into the embossing plate to determine a position and/or an orientation of the embossing plate in the embossing field.

4. An embossing tool for producing bipolar plates having an embossing field wherein the embossing field has a plurality of embossing plates arranged adjacent to one another.

5. The embossing tool in accordance with claim 4, wherein at least one section of the embossing field is formed from embossing plates identical to each other.

6. The embossing tool in accordance with claim 4, wherein at least one of the embossing plates has a positioning structure and/or an orientation structure for determining a position and/or an orientation of the embossing plate relative to another embossing plate and/or the embossing field.

7. The embossing tool in accordance with claim 6, wherein the positioning structure and/or the orientation structure includes a fastening device for fixing the embossing plate to another embossing plate and/or to the embossing field.

8. The embossing tool in accordance with claim 4, wherein the embossing plates are obtained by means of an erosion method.

9. The method in accordance with claim 2, comprising step d) introducing, in a fourth step, a positioning structure and/or an orientation structure into the embossing plate to determine a position and/or an orientation of the embossing plate in the embossing field.

10. The embossing tool in accordance with claim 5, wherein at least one of the embossing plates has a positioning structure and/or an orientation structure for determining a position and/or an orientation of the embossing plate relative to another embossing plate and/or the embossing field.

11. The embossing tool in accordance with claim 5, wherein the embossing plates are obtained by means of an erosion method.

12. The embossing tool in accordance with claim 6, wherein the embossing plates are obtained by means of an erosion method.

13. The embossing tool in accordance with claim 7, wherein the embossing plates are obtained by means of an erosion method.
